(19) United States
(12) Patent Application Publication
(10) Pub. No.: US 2014/0173012 A1
(43) Pub. Date: Jun. 19, 2014

(54) SYSTEM AND METHOD FOR MANAGING EMAIL SEND JOBS

(71) Applicants: James Michael Ciancio-Bunch, Indianpolis, IN (US); Tom Waltz, Carmel, IN (US); Jonathan David Bennett, Columbus, IN (US)

(72) Inventors: James Michael Ciancio-Bunch, Indianpolis, IN (US); Tom Waltz, Carmel, IN (US); Jonathan David Bennett, Columbus, IN (US)

(73) Assignee: ExactTarget, Inc., Indianapolis, IN (US)

(21) Appl. No.: 14/236,489

(22) PCT Filed: Aug. 6, 2012
(86) PCT No.: PCT/US12/49791

§ 371 Date: Jan. 31, 2014

Related U.S. Application Data
(60) Provisional application No. 61/515,561, filed on Aug. 5, 2011.
(60) Provisional application No. 61/547,419, filed on Oct. 14, 2011.

(51) Int. Cl. G06Q 10/10

(52) U.S. Cl. CPC G06Q 10/107
USPC 709/206

(57) ABSTRACT

A method and system for managing email send jobs. Managing email send jobs includes constructing and building a plurality of emails based upon an executable process, wherein each of the plurality of emails comprises an activity data and at least one email recipients. Managing email send jobs also includes routing each of the plurality of emails to a queue at a location, wherein the location is determined based in part upon proximity to at least one of the at least one email recipients, processing each of the plurality of emails within each queue, injecting each of the plurality of emails into a mail transfer agent at the location, and sending each of the plurality of emails to the at least one email recipients.

### CROSS REFERENCE TO RELATED APPLICATIONS

The present application claims the benefit of commonly owned U.S. Provisional Patent Application Ser. No. 61/515,561 filed Aug. 5, 2011, and U.S. Provisional Patent Application Ser. No. 61/547,419 filed Oct. 14, 2011, both of which are hereby incorporated by reference in their entirety.

### BACKGROUND

Email communications have become the preferred vehicle for businesses to send advertisements, marketing materials, and other information to their customers or potential customers. Such electronic communications make it possible to reach individuals all over the world in a short period of time. Current systems used by businesses for assembling and sending email communications utilize a singular, linear process that acquires a Send Job, divides the Send Job into multiple batches, and delivers each batch to a single worker thread, which creates the email message, injects the email to a Mail Transfer Agent (MTA), and records data about the send.

Because most email communications are time-sensitive, it is advantageous to be able to send the messages to the recipients as quickly as possible and so recipients of the same or similar messages receive the messages at about the same time. However, the current systems used by businesses for assembling and sending email communications to groups of individuals often are unable to rapidly send the communications because of bottlenecks in the assembly and send process. Even after the communications are sent, the messages themselves are sometimes rejected from being delivered to or filtered from ever reaching the intended recipients because of the design of the current systems.

Accordingly, there exists a need for a system and method that can efficiently, reliably, and quickly assemble and send email communications to recipients.

### SUMMARY

The present disclosure discloses a method and system for managing email Send Jobs.

In an exemplary embodiment of a method for managing email Send Jobs, the method includes constructing and building a plurality of emails based upon an executable process, wherein each of the plurality of emails comprises an activity data and at least one email recipient. The method also includes routing each of the plurality of emails to a queue at a location, wherein the location is determined based in part upon proximity to at least one of the at least one email recipients. The method also includes processing each of the plurality of emails within each queue and injecting each of the plurality of emails into a mail transfer agent at the location. The method also includes sending each of the plurality of emails to the at least one email recipient.

### BRIEF DESCRIPTION OF DRAWINGS

The features and advantages of this disclosure, and the manner of attaining them, will be more apparent and better understood by reference to the following descriptions of the disclosed methods and systems, taken in conjunction with the accompanying drawings, wherein:

FIG. 1 shows a flowchart of a method of managing email Send Jobs according to at least one embodiment of the present disclosure.

FIG. 2 shows a flowchart of a method of managing email Send Jobs according to at least one embodiment of the present disclosure.

FIG. 3A shows a flowchart of a method of managing email Send Jobs according to at least one embodiment of the present disclosure.

FIG. 3B shows a flowchart of a method of managing email Send Jobs according to at least one embodiment of the present disclosure.

FIG. 4 shows a system of managing email Send Jobs according to at least one embodiment of the present disclosure.

FIG. 5 shows a system of managing email Send Jobs according to at least one embodiment of the present disclosure.

FIG. 6A shows a system of managing email Send Jobs according to at least one embodiment of the present disclosure.

FIG. 6B shows a system of managing email Send Jobs according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes a system and method for managing email Send Jobs. As generally used herein, a “Send Job” describes the entire process of delivering an email to an audience of subscribers. In at least one embodiment of the present disclosure, the Send Job is broken up into distinct operations, namely construction of an email and sending an email. With the operations of the Send Job distinct from one another, the Send Job process can be spread out across multiple programs, devices, and geographic locations. Such distribution of Send Job operations to various resources provides for an efficient and reliable process of managing email Send Jobs.

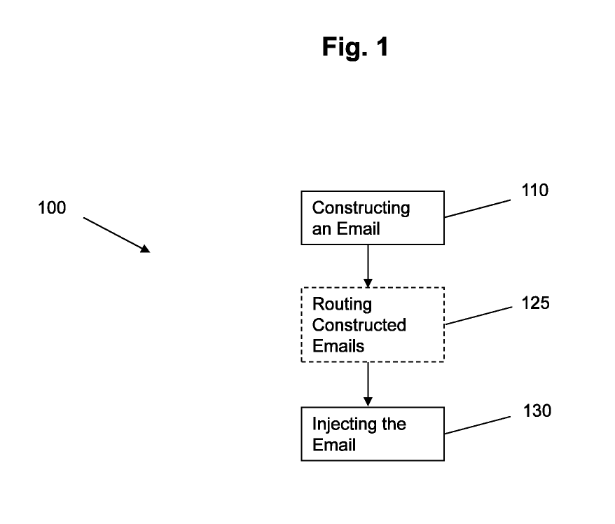

FIG. 1 shows a method of managing an email Send Job 100 according to at least one embodiment of the present disclosure. As shown in FIG. 1, the method 100 includes the step 110 of constructing an email. The step 110 of constructing an email includes fetching or receiving activity data, such as, for example, subscribers, subscriber information, data extensions, informational content, and templates, for building an email. The information for building an email may be stored in databases, servers, or other electronic systems and may include rules, permissions, text, images, and the like. The information may also include, for example, various types of content. Content, in a general sense, is any visual representation that can be injected into the body of an email. Such content may include actual hard-coded information specific to a given email, text or design that is saved and reused among many subscribers over many emails (e.g. legal disclaimers), image libraries that can be pulled and reused in multiple communications to multiple subscribers (e.g. company logos), references to content that are determined when the email is opened rather than when the email is sent, and many other formats.

As mentioned above, the step 110 of constructing an email includes fetching or receiving activity data. The distribution of activity data is initially scheduled. As described herein, this scheduling of a Send Job involves a choice between one of three options. In the first option, the Send Job can be scheduled to be performed entirely on one server with an Outbound Mail Manager (OMM). It should be noted that the server may include multiple OMMs such that Send Jobs may be scheduled to different OMMs. Each OMM may be responsible for physical construction of Simple Mail Transfer Protocol (SMTP) data, directing the SMTP data to the appropriate send center for injection into a Mail Transfer Agent (MTA) at the send center for delivery to the intended recipients, injecting the SMTP data into an MTA, recording the send information for individual jobs, and managing computing resources, among other duties relating to Send Jobs.

With the second option, the Send Job can be scheduled to be performed among separate servers at one geographic location. In such a case, one or more OMMs on a plurality of servers can physically construct SMTP data, direct the SMTP data to the appropriate send center for injection into a MTA at the send center for delivery to the intended recipients, inject the SMTP data into an MTA, record the send information for individual jobs, manage computing resources, and perform other duties related to Send Jobs. Finally, with the third option, the Send Job can be scheduled to be performed among separate servers at more than one geographic location. If the email assembly and send process is divided among a plurality of servers at more than one geographic location, a server will typically generate activity data and distribute the activity data to geographically distinct locations where one or more servers at each geographic location processes the activity data. It should be noted that the database servers described herein can process all or a subset of the activity data. Typically, the servers will only initiate Send Jobs for a particular subset of the activity data. Also, the database servers can communicate record changes to other database servers in order to keep data in sync across the servers.

The routing of activity data per scheduling may be based on a variety of factors and attributes. The factors and attributes may include, for example, the domain of the recipient's email address, the country of origin of the email sender, the country of the intended recipient, the health, viability, or level of activity (e.g., how busy it is) of various servers, and size of the email, among others. For instance, one or more servers may be chosen for constructing an email for a Send Job based upon the characteristics of the Send Job and the size of the queue for each of a plurality of servers.

The step 110 of constructing an email also includes building an email, which may include, for example, arranging retrieved information, data substitution, script injection, validation of data (e.g., valid HTML), optimization of content (e.g., SMTP), and link wrapping. The positioning of text and images for an email may be determined, for example, by one or more rules. The step 110 of constructing an email further includes cleanup, which may include, for example, write-back of link data, write to queue, write to control a database, and recording links. The details recorded in step 110 may include data corresponding to the emails that are generated, elapsed time metrics, and any processing errors encountered, among other things. The links embedded in each email may also be recorded. Using the data recorded about each link, subscriber behavior may be tracked in reaction to content viewed in an email.

As shown in FIG. 1, the method 100 also includes the step 130 of injecting the email into a network, such as through an MTA. In the system and method of the present disclosure, the tasks of building an email and injecting an email into an MTA are separate and distinct operations. Therefore, the step 110 and step 130 of method 100 are separate and distinct, which means they are performed asynchronously.

In at least one embodiment, steps 110 and 130 may be server programs that are run in separate executable processes. These separate executable processes may be run on the same physical machine or machines. However, these separate executable processes may be run on physically separate machines, which may be located in geographically distinct locations or datacenters. The division of the construction of an email and injection of an email allows for a more efficient use of computing resources and a more reliable process. For example, a program configured to perform step 110 may be able to continue running even though another program configured to perform step 130 is backed-up and/or running at a slower pace than the program performing step 110. As a result, the division of the two steps 110 and 130 allows the method to manage large groups of emails (i.e., improved scalability).

Generally, multiple MTA's may be utilized to exchange an email until it reaches the destination MTA for the email. Often times, this transfer among MTAs accounts for the largest queue in the pipeline for email delivery to the recipient. As shown in FIG. 1, the method 100 may optionally include step 125 of distributing or routing constructed emails to appropriate Send Centers. As used herein, a Send Center may be described as a system including at least a mail injector, MTA, and a router for sending emails. In at least one embodiment, a plurality of Send Centers may be located in different locations. For example, one Send Center may be located with the system for constructing emails, while another Send Center may be located in another country.

The routing of email messages to particular Send Centers of step 125 may be based on a variety of factors and attributes. The factors and attributes may include, for example, the domain of the recipient's email address, the country of origin of the email sender, the country of the intended recipient, the health or viability of Send Centers, ISP rules on rates of injection, number of connections, and average time of injection, and size of the email, among others. For instance, a Send Center may be chosen for the injection of an email for a Send Job based upon the characteristics of the Send Job and the current state of a plurality of Send Centers. In one example, a Send Center may be chosen based upon its physical proximity to the intended recipients of the email or the email service provider. By physically locating the original MTA injection near the target MTA for the recipient, the time spent in a queue for injecting the email may be shortened significantly.

The step 125 may include determining the current state of one or more Send Centers and using this information and characteristics of Send Jobs to determine which Send Center should be tasked with the MTA injection step of a given email inside of a Send Job. That is, email messages can be routed differently based upon the current state of the Send Centers. For example, if one Send Center is experiencing high rates of queuing, then Send Jobs may be routed to a different Send Center that has spare capacity. It should also be noted that step 125 may be performed on the same server as the target MTAs (e.g., Hotmail), thereby eliminating the need to conduct an SMTP session across a network and multiple SMTP sessions from MTA to MTA. When the Send Job execution is hosted in the same geographic location as the target MTA (such as, for example, on the same server), it is generally referred to as the co-location of a Send Job execution with the target MTA.

In addition to the potential reduction in time spent in a queue, it should also be noted that the reduction in the number of MTA's that the email message encounters may also improve the chances of the email message being received by the intended recipient. That is, for some email service providers, a large number of MTA hits indicates that the email message may not be trustworthy, which can result in the email message being caught up in a spam blocker or other email filter. Therefore, by reducing how many MTAs the email passes through, the odds of the email message actually being received by the intended recipient without being filtered out may be improved. Distributed Send Centers may also provide for global redundancy in the case of a catastrophic disaster in one geographic location. Email messages can be routed to different Send Centers based upon the current viability of the Send Centers.

It should be noted that the method 100 may optionally include a step of receiving one or more Send Job instructions and dividing the Send Job instructions into batches. The method 100 may additionally include the step of delivering the one or more batches to a worker engine of a server.

Also, the method 100 may optionally include a step of determining when and where to construct an email and a step of determining when to inject the email. Each determination may be based on a variety of factors, rules, attributes, stored information on the recipients of the emails, likelihood of recipient to open email, temporal targeting, behavioral analysis, and the like. For example, suppose the incoming Send Jobs included three intended recipients, A, B, and C. Based upon the stored information about the recipients, it is known that A typically opens emails or accesses social networking sites in the morning, B opens emails or accesses social networking sites in the afternoon, and C opens emails or accesses social networking sites late at night. Using this information, the email (or social network post) for A may be created and sent to A in the early morning, the email (or social network post) for B may be created and sent to B later in the morning, and the email (or social network post) for C may be created and sent to C in the afternoon. As shown in this example, using the system and method of the present disclosure, the resources for building and sending emails may be optimized, and the intended recipients may receive the emails (or social network posts) when they will most likely access them.

In another example, suppose the Send Jobs included two intended recipients, M and N, and based upon the stored information about the recipients, it is known that M does not open emails very often, while N opens most emails and has a high rate of purchasing based upon emails. Using this information, the email for N may be created and sent to N prior to the creation and sending of the email to M. As such, in an email campaign or the like, emails may be sent first to the recipients that are more likely to take part in the campaign.

It should also be noted that the information in step 110 may be divided among multiple servers at one or more geographic locations. One or more programs on servers at geographically distinct locations may construct all of the emails or may only construct a subset of the total number of emails. The programs on a plurality of servers at distinct geographic locations may construct the totality of emails but only perform step 125 or step 130 on a subset of constructed emails.

Also, the method 100 may optionally include a step of determining what form to deliver the message in a Send Job. While the system and method of the present disclosure is discussed primarily in relation to emails, it should be noted that the system and method may apply to social network postings and social network message delivery. Each determination may be based on a variety of factors, rules, attributes, stored information on the recipients, temporal targeting, behavioral analysis, and the like. For example, if based upon the stored information on intended recipient Z, it is known that Z checks his work email address more than his personal email address, then the email to Z may be sent to his work email address. If Z were to check a particular social networking page more than his email addresses, then the message to Z may be posted to his social networking page.

The method 100 may also include monitoring how subscribers are reacting to the messages they have received. This may include measuring various metrics, including the “open rates” (which emails have been opened vs. which have not), delivery rates, click-through rates on embedded URL's, and other metrics. This monitoring aspect may allow users the ability to finely measure what about the communication to a subscriber has been effective, and it allows users to roll up and classify that behavior around different categories of subscribers.

Additionally, the method 100 may include simultaneous processing of multiple programs running on servers at geographically distinct locations to improve efficient use of computing resource and reliability of the method. In one embodiment, the step 110 of constructing an email includes a plurality servers simultaneously retrieving information and building emails. The plurality of servers in step 110 may coordinate the status of the running processes. In the event that one or more servers becomes unavailable or does not meet performance thresholds for constructing emails, the coordination between the plurality of servers enables the remaining servers to pick up where the unavailable or slowly performing server left off in the process. This is advantageous by providing high availability and improved performance of the method.

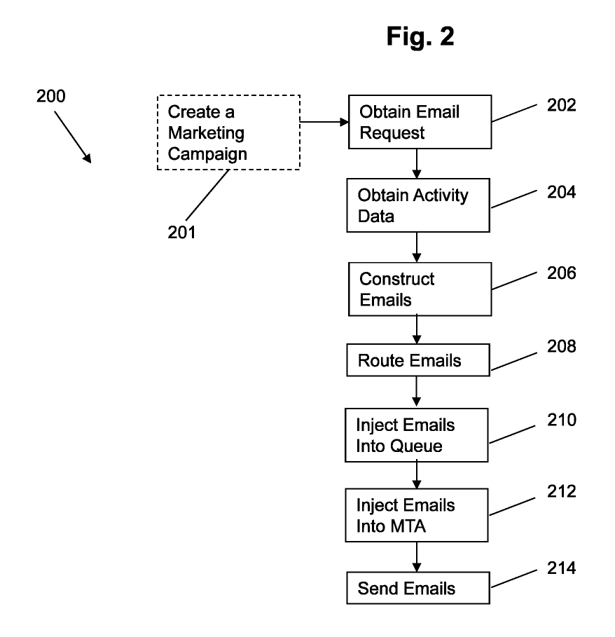

Referring now to FIG. 2, there is shown a flowchart of a method that may be utilized to manage Send Jobs according to at least one embodiment of the present disclosure. The method 200 includes the steps of creating a marketing campaign in step 201, obtaining an email request in step 202, obtaining activity data in step 204, constructing emails in step 206, routing emails in step 208, injecting emails into a queue in step 210, injecting emails into an MTA in step 212, and sending emails in step 214.

In at least one embodiment of the present disclosure, the method 200 includes the step of creating a marketing campaign in step 201. It should be appreciated that the step 204 is optional and the method 200 may manage Send Jobs without the creation of a marketing campaign. In the step 201 of creating a marketing campaign, a marketing campaign is defined which set forth parameters defining the building and sending of communications to an audience. The parameters defined in a marketing campaign include, but are not limited to, defining the demographic of consumers for the audience, such as, for example, age, sex, and geographic location, defining the schedule in which communications are to be sent, and defining the content to include in such communications. In at least one embodiment of the present disclosure, the marketing campaign may define the content in which to be included in communications. In such an embodiment, the marketing campaign may statically define content or include dynamic content. Static content may include, but is not limited to, text, pictures, hyperlinks, and other information that is inputted at the time in which the marketing campaign is created or thereafter and is not generated on the fly during the email building process. Dynamic content includes content that is generated on the fly during the email building process, when any communications are sent, or when emails are opened, such as, for example, content pulled from a webpage at the time communications are sent or content that is pulled from a webpage when an email is opened by the recipient.

For example, a marketing campaign may define a newsletter for a retail business. In this example, the marketing campaign is defined to build and send emails once a week to all persons who have signed up to receive the retail business' newsletter. In this example, the marketing campaign defines the dynamic content within each email to include offerings from the retail business which are available on the retail business' web page. In this example, when the emails are sent to the user, the content within each email is pulled directly from the webpage when the email is built.

In at least one embodiment of the present disclosure, the method 200 includes obtaining a request to build and send emails in step 202. In such an embodiment, a request to send emails obtained in step 202 defines the group and content to send emails. In at least one embodiment of the present disclosure, the request to send emails may include information identifying each recipient specifically, such as, for example, by email address, first name, and last name. In at least one embodiment of the present disclosure, the request to send emails may include information identifying each recipient by type, such as, for example, through demographic and/or sales information, like age, geographic location, birthday, product purchase history, or other behavioral marketing information.

For example, an email request obtained in step 202 may include a request to send emails to all customers who have purchased an item over the last 25 days in a store. In this example, the request also may contain the content of a preferred customer coupon wherein the customers may receive a discount upon their next purchase at the store. In another example, the email request may include a request to send emails to all male customers in Chicago, Ill. In this example, the request also may contain the content of an advertisement for a discounted shave at a barbershop in Chicago, Ill.

In at least one embodiment of the present disclosure, the marketing campaign defined in step 201 creates the email request obtained in step 202 according to a schedule and defined content with a marketing campaign defined in step 201. In such an embodiment, the marketing campaign defined in step 201 may create multiple email requests obtained in step 202 based on the schedule defined within the marketing campaign.

It should be appreciated that the email request may be obtained on a server coupled to a network and/or the Internet. It should be appreciated that the email request may be obtained through an application programming interface, sent from an external customer, or sent from an internal service. It should be appreciated that the infrastructure in which the email request is obtained in step 202 may be geographically distinct from the infrastructure in which the marketing campaign is created in step 201.

In at least one embodiment of the present disclosure, activity data is obtained in step 204. The activity data obtained in step 204 includes the type of information necessary to build and send emails, including informational content and recipient data. In at least one embodiment of the present disclosure, the activity data obtained in step 204 is related to the email requested obtained in step 202. It should be appreciated that the activity data obtained in step 204 may reside within a relational database, list, or other data structure and such data structure may be available through a server. It should be appreciated that the server where the activity data is obtained in step 204 may be in a geographically distinct location from the infrastructure where the marketing campaign is created in step 201 and/or the email request is obtained in step 202.

In at least one embodiment of the present disclosure, the activity data is used to construct and build emails in step 206. It should be appreciated that the emails may be constructed and built on a single server or be built among multiple servers with each server building a subset of the emails. In at least one embodiment of the present disclosure, after the emails are built in step 206, the emails are routed to the appropriate Send Center in step 208. In at least one embodiment of the present disclosure, the emails are routed to the Send Center that is closest to the location of the recipient of the email. The appropriate Send Center may be the geographically closest Send Center to the location of the recipient or it may be the Send Center that has the lowest latency and/or highest throughput for the recipient.

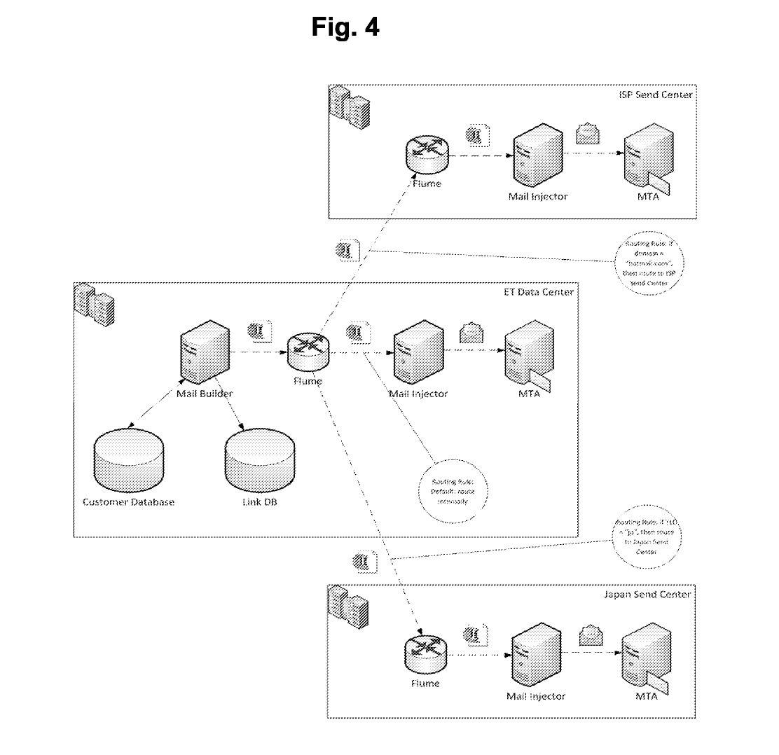

In at least one embodiment of the present disclosure, the appropriate Send Center may be determined by evaluating the top-level domain of the email address of the recipient. For example, if the recipient has an email address with the top-level domain of “.jp”, then the appropriate Send Center may be a Send Center located in Japan. In another example, if the recipient has an email address with the top-level domain of “.us”, then the appropriate Send Center may be the Send Center located in the United States. A system according to at least one embodiment of the present disclosure to implement the method 200 is displayed on FIG. 4. As shown in FIG. 4, each Send Center includes a Mail Injector and MTA.

In at least one embodiment of the present disclosure, the appropriate Send Center is evaluated by evaluating the domain of the email recipient. In such an embodiment, the appropriate Send Center is determined by requesting the MX record in DNS for the domain of the recipient's email address. Then, the appropriate Send Center is determined by performing IP address geolocation on the resulting IP address. For example, if the recipient's email address is user@exacttarget.com, then the MX record for “exacttarget.com” is evaluated. In this example, if the resulting MX record is mx.exacttarget.com with the IP address of 10.10.10.1, then IP address geolocation is performed on the IP address 10.10.10.1 to determine which Send Center is geographically closest to the mail server associated with the exacttarget.com domain.

In at least one embodiment of the present disclosure, the emails are injected into a queue in step 210 after arriving at the appropriate Send Center. The queue may be, but is not limited to, any type of queuing data structure which supports enqueue/dequeue and/or push/shift operations, such as, for example, a first in-first out data structure, linked list, persistent queue, or a stack.

In at least one embodiment of the present disclosure, the emails are routed to the appropriate Send Center in step 208 after injecting the emails into a queue in step 210. In such an embodiment, the emails are built and injected into a queue prior to processing before being routed to the appropriate Send Center. It should be appreciated that this embodiment allows the emails constructed in step 206 to be immediately stored in a queue in step 210 and then evaluated at a later time to be routed to the appropriate Send Center in step 208. In such an embodiment, the emails may be injected into a second queue at the appropriate Send Center.

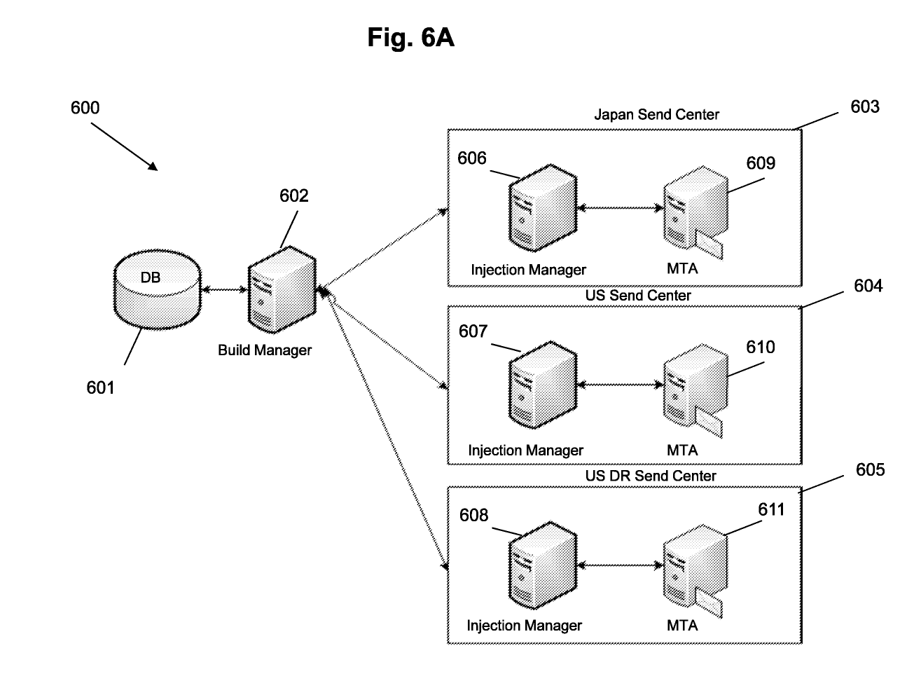

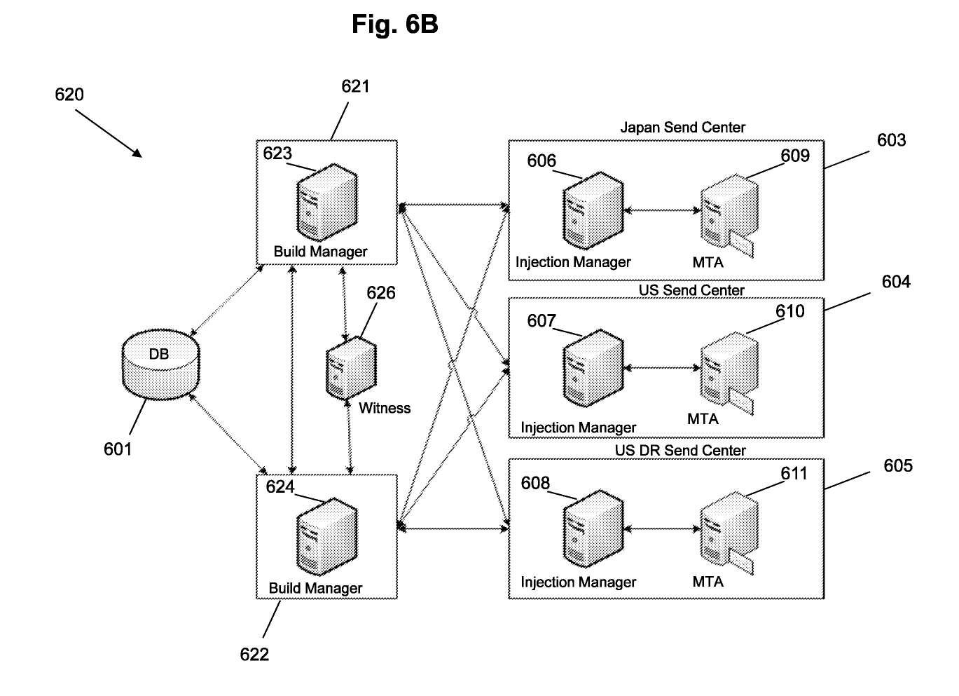

In at least one embodiment of the present disclosure, each email is injected into an MTA in step 212. In at least one embodiment of the present disclosure, each MTA resides at a Send Center. In such an embodiment, each email is injected into the MTA at the Send Center in which the email was routed in step 208. For example, an email routed to a Send Center in Japan in step 208 is injected into the queue residing at the Japan Send Center in step 210 and the email is injected into the MTA at the Japan Send Center in step 212. After injection into the MTA in step 212, each email is sent to the intended recipient in step 214. One example of a system to support execution of the method 200 is displayed in FIG. 6A.

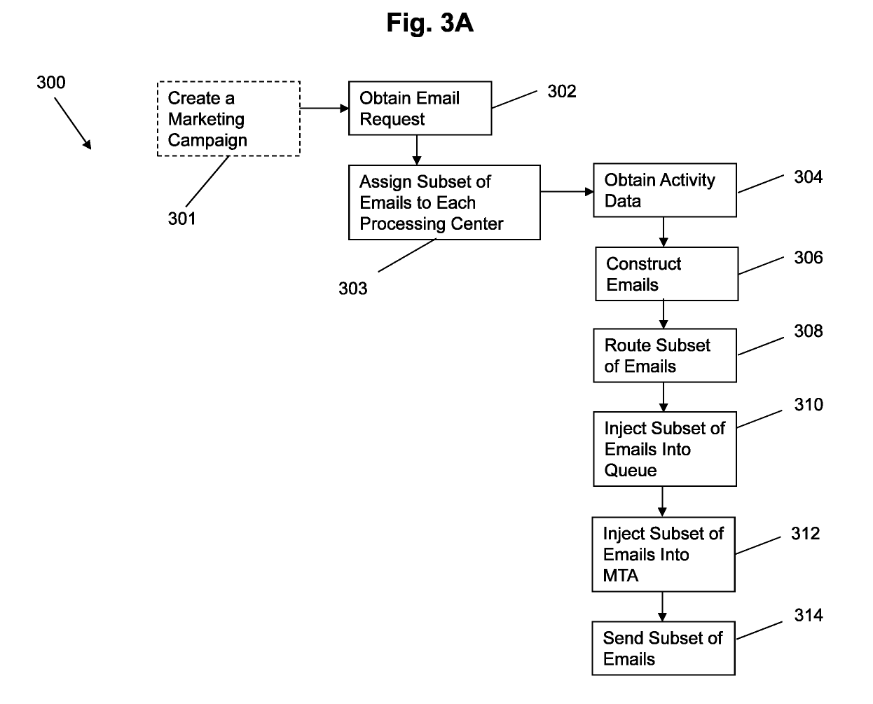

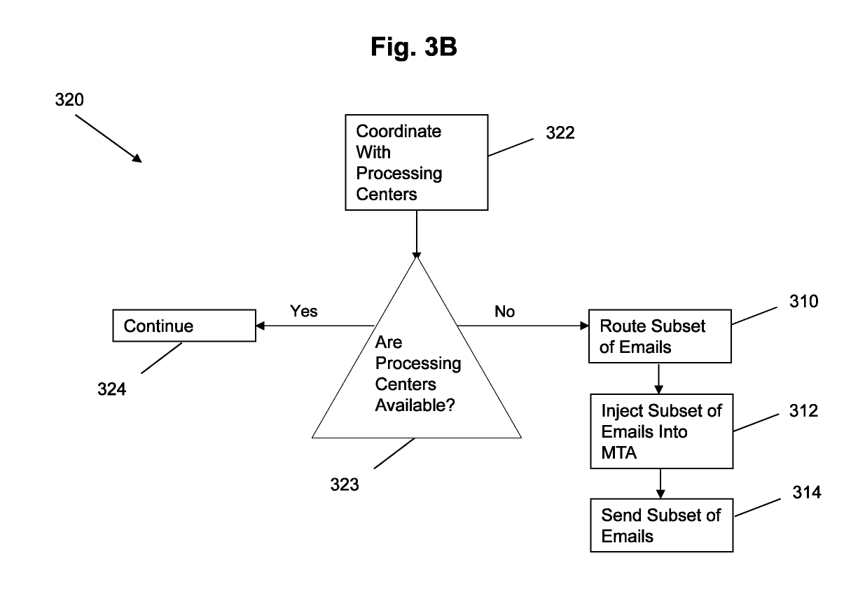

Referring now to FIG. 3A, there is shown a flowchart of a method for managing Send Jobs according to at least one embodiment of the present disclosure. As shown in FIG. 3A, the method 300 represents an extension of the method 200 disclosed in FIG. 2 in which the method 300 enables the construction of emails at multiple locations. In at least one embodiment of the present disclosure, the method 300 enables the construction of emails at multiple geographically distinct locations to provide a layer of protection for the Send Jobs from a disaster situation. In such an embodiment, in the event that one geographically distinct location becomes unavailable, the method 300 may continue to process any active Send Job.

The method 300 includes the steps of creating a marketing campaign in step 301, obtaining an email request in step 302, designating or assigning a subset of emails to each processing center in step 303, obtaining activity data in step 304, constructing emails in step 306, routing the subset of emails to the appropriate Send Centers in step 308, injecting emails into a queue in step 310, injecting the subset of emails into an MTA in step 312, and sending the subset of emails in step 314.

In at least one embodiment of the present disclosure, the method 300 includes the additional step of designating or assigning a subset of emails to each processing center in step 303. In such an embodiment, the method 300 is executed to manage Send Jobs across multiple processing centers. Processing centers may include infrastructure residing in geographically distinct locations, infrastructure residing in the same data center, or multiple instances of cloud-computing resources. In a preferred embodiment, each processing center is geographically distinct from each other or utilizing disparate infrastructure in order to allow a subset of the processing centers to be impacted in a disaster situation, such as, for example, a distributed denial of service attack, a hurricane, tornado, power outage, or other event that may cause infrastructure to become unavailable.

In at least one embodiment of the present disclosure, in the step 303 of designating or assigning a subset of emails to each processing center, each processing center is assigned a subset of the total amount of emails to be processed in the Send Job. For example, in the event that there are two processing centers, one processing center may be assigned the emails associated with recipients who have an even recipient identifier and the second processing center may be assigned the emails associated with recipients who have an odd recipient identifier. In another example, the list of recipients may be divided in half through another method. It should be appreciated that the step of designating or assigning a subset of emails to each processing center may not designate or assign an even amount of emails to each processing center. For example, in the event that one processing center is able to build and construct emails at a much faster rate than another processing center, the processing center with the higher throughput may be assigned more emails than the processing center with a lower throughput. It should be appreciated that a variety of designating or assigning functions may be used and that the only requirement of the designation or assignment function is that every email is designated or assigned.

In at least one embodiment of the present disclosure, the step 303 of designating or assigning a subset of emails to each processing center occurs after the activity data is obtained in step 304. In such an embodiment, in the event that the email request obtained in step 302 seeks to send emails to recipients that match a specific demographic information, such as, for example, all women who have purchased a product in the last thirty days, then a subset of emails may not be designated or assigned to each processing center in step 303 until after the activity data is obtained in step 304 in order to determine the number of emails that need to be sent in the Send Job. In such an embodiment, the activity data is obtained in step 304 prior to designating or assigning a subset of the emails to each processing center.

In at least one embodiment of the present disclosure, each processing center obtains the activity data associated with all of the emails needed to be sent in the Send Job, not just the subset designated or assigned to the processing center, in step 304. In such an embodiment, the totality, or at least a portion of e-mails not designated to the particular processing center, of activity data is obtained in step 304 at each processing center in order to allow each processing center to complete the Send Job for emails not designated or assigned to such processing center in the event that the processing center in which such emails was designated or assigned becomes unavailable. For example, if there are two processing centers, A and B, each designated or assigned one half of the emails, then processing center A obtains the activity data associated with emails designated or assigned to processing center A and processing center B in order to execute the Send Job for emails designated or assigned to processing center B in the event that processing center B becomes unavailable. In at least one embodiment of the present disclosure, each processing center constructs and builds emails in step 306. In at least one embodiment of the present disclosure, each processing center builds and constructs all of the emails associated with the Send Job in step 306. It should be appreciated that it is within the scope of the present disclosure for any number of processing centers to be used, and any single processing center may obtain less than the totality of activity data for all other processing centers or any other processing center, but rather a subset of the totality of send data.

In at least one embodiment of the present disclosure, for faster throughput in the event that a faster processing center completes the step of routing the subset of emails assigned to the faster processing center to the appropriate Send Center 310, the faster processing center starts to route subsets of emails assigned to slower processing centers that have not yet been routed. In such an embodiment, the slower processing centers do not route the subsets of emails that have been routed by the faster processing center.

It should be appreciated that for faster throughout, each processing center may not be required to obtain activity data in step 304 or construct emails in step 306 for emails not assigned to such processing center. It should be appreciated that omitting these steps in the method 300 may provide faster throughput in the Send Job while potentially sacrificing the disaster recovery benefits of the method 300.

In at least one embodiment of the present disclosure, each processing center routes the subset of emails in which the processing center was assigned to the appropriate Send Center in step 308. In such an embodiment, each processing center identifies the appropriate Send Center for each email in which the processing center was assigned and routes each email to the appropriate Send Center. In at least one embodiment of the present disclosure, each email is injected into a queue in step 310, injected into an MTA at the appropriate Send Center in step 312, and each email is sent through the MTA at the appropriate Send Center in step 314.

For example, in the event of two processing centers, A and B, for each email that processing center A was assigned, processing center A identifies the appropriate Send Center for the email and routes the email to the appropriate Send Center in step 308. However, in such an embodiment, processing center A does not identify nor route the emails that were assigned to processing center A. In such an embodiment, processing center B identifies and routes the emails in which processing center B was assigned to the appropriate Send Center in step 308. Upon arriving at the appropriate Send Center, each email is injected into the queue at the Send Center in step 310, processed in the queue according to the queue rules and thereafter injected into the MTA in step 312, and each email is sent to the recipient from the appropriate Send Center in step 314.

Referring now to FIG. 3B, there is shown a flowchart of a method to manage email Send Jobs according to at least one embodiment of the present disclosure. As displayed in FIG. 3B, the method 320 is executed with the method 300 to coordinate activities between the processing centers. In at least one embodiment of the present disclosure, in the event that a processing center becomes unavailable, the remaining processing centers will execute the method 300 for the emails assigned to the unavailable Send Center in order to complete the Send Job. In at least one embodiment of the present disclosure, the method 320 includes the steps of coordinating with processing centers 322, determining whether the processing centers are available in step 323, and then either continuing with the method 300 in step 324 or routing the subset of emails of the unavailable processing center to the appropriate Send Center in step 308, injecting such emails into a queue in step 310, injecting such emails into the MTA at the appropriate Send Center in step 312, and sending such emails to the recipients in step 314.

In at least one embodiment of the present disclosure, the method 320 includes coordinating with processing centers in step 322. In such an embodiment, each processing center coordinates the status of the Send Job with the other processing centers in step 322. In at least one embodiment of the present disclosure, the coordination between processing centers includes the passing of information between processing centers necessary in order to allow one processing center to process the assigned subset of emails for an unavailable processing center. Information passed between the processing centers for coordination may include, but is not limited to, the email identifier of each email routed to the appropriate Send Center and a heartbeat status or other monitoring status to indicate that the processing center is available. It should be appreciated that the monitoring status may include a status generated from a third-party monitoring tool, such as, for example IBM Tivoli, Microsoft System Center Operations Manager, HP SiteScope, Nagios, or other third-party monitoring tool.

In at least one embodiment of the present disclosure, the method 320 includes determining whether each processing center is available in step 323. In at least one embodiment of the present disclosure, the availability of each processing center is determined in step 323 based on information obtained in coordination between processing centers in step 322. In at least one embodiment of the present disclosure, in the event that the processing centers are determined to be available in step 323, then the method 320 returns an indication that the method 300 may continue without modification.

Alternatively, in the event that the heartbeat status or third-party monitoring tools identifies a processing center as unavailable, then the processing center is determined to be unavailable in step 323, and the remaining processing centers process the assigned emails from the unavailable processing center. In such an event, the processing steps for the assigned emails from the unavailable processing center include routing the subset of emails to the appropriate Send Center in step 308, injecting the emails into the queue in step 310, injecting the emails into the MTA in step 312, and sending the emails to the recipients in step 314.

In at least one embodiment of the present disclosure, in the event that one of the processing centers is determined to be unavailable in step 323, the emails assigned to the unavailable processing center may be assigned amongst the remaining processing centers in any fashion, such as for example, by assigning all of the emails to a single processing center, assigning an equal amount of emails to each remaining processing centers, or assigning emails to each remaining processing center based on the throughput and/or current load of each remaining processing center.

In at least one embodiment of the present disclosure, the method 320 is executed numerous times throughout the execution of the method 300 to manage a Send Job. In such an embodiment, the method 320 may be executed at each step in the method 300 or on a time-based interval. In at least one embodiment of the present disclosure, the method 320 is executed each time an email is routed to the appropriate Send Center. In such an embodiment, coordinating between the processing centers in step 322 with this frequency enables the processing centers to have the most current status as to each email that has been processed and routed to the appropriate Send Center. In the event that a processing center is determined to be unavailable in step 323, the remaining processing centers will have the most current status as to which emails need to be assigned due to the unavailable processing center. One example of a system to support execution of the method 300 and the method 320 is shown in FIG. 6B.

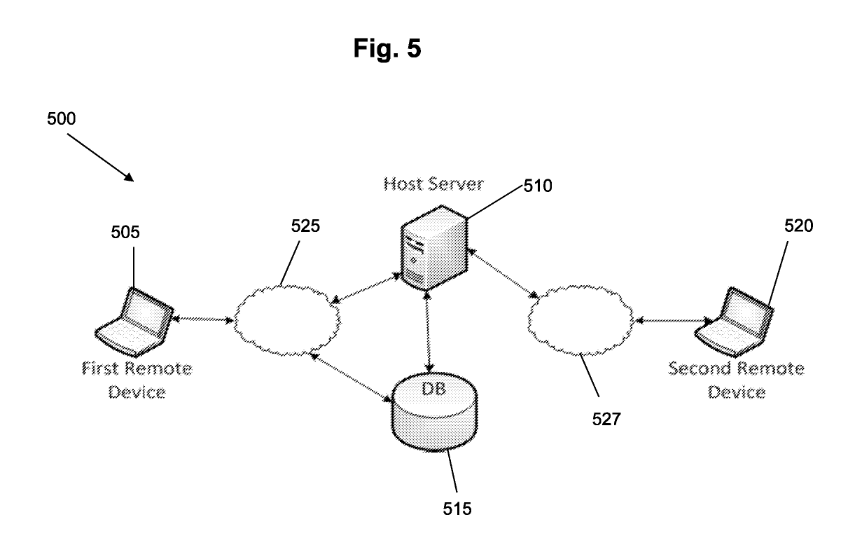

Referring now to FIG. 5, there is shown one embodiment of the components of a system that may be utilized to manage Send Jobs. The system 500 comprises a first remote device 505, a host server 510, a database 515, a second remote device 520, and computer networks 525, 527. For purposes of clarity, only one first remote device 505 and second remote device 520 are shown in FIG. 5. However, it is within the scope of the present disclosure, and it will be appreciated by those of ordinary skill in the art, that the system 500 may have two or more first remote devices 505 and/or second remote devices 520 operating at the same time. In the embodiment shown in FIG. 5, first remote device 505 is operated by an e-mail sender and second remote device 520 is operated by an e-mail recipient. However, it is within the scope of the present disclosure, and will be appreciated by one of ordinary skill in the art, that system 500 may simply comprise a single remote device used by both the e-mail sender and the e-mail recipient.

In one embodiment of the disclosed system, first remote device 505 and second remote device 520 are computers, computing devices, or systems of a type well known in the art, such as a mainframe computer, workstation, personal computer, laptop computer, hand-held computer, cellular telephone, or personal digital assistant. First remote device 505 and second remote device 520 comprise such software, hardware, and componentry as would occur to one of skill in the art, such as, for example, one or more microprocessors, memory systems, input/output devices, device controllers, and the like. First remote device 505 and second remote device 520 also comprise one or more data entry means (not shown in FIG. 5) operable by users of first remote device 505 and second remote device 520 for data entry, such as, for example, a pointing device (such as a mouse), keyboard, touch screen, microphone, voice recognition, and/or other data entry means known in the art. First remote device 505 and second remote device 520 also comprise a display means (not shown in FIG. 5) which may comprise many of the well known display means such as cathode ray tube displays, liquid crystal diode displays, light emitting diode displays, and the like, upon which information may be displayed in a manner perceptible to the user.

A software means known in the art for retrieving e-mail messages from an e-mail mailbox including, but not limited to, software means for viewing e-mail messages, for composing a response to an e-mail message, and for deleting an e-mail message may be resident on, or accessible by, second remote device 520 that is operated by the e-mail recipient.

Host server 510 comprises one or more server computers, computing devices, or systems of a type known in the art. Host server 510 further comprises such software, hardware, and componentry as would occur to one of skill in the art, such as, for example, microprocessors, memory systems, input/output devices, device controllers, display systems, and the like. Host server 510 may comprise one of many well known servers, such as, for example, IBM®'s AS/400® Server, IBM®'s AIX UNIX® Server, or MICROSOFT®'s WINDOWS NT® Server. In FIG. 5, host server 510 is shown and referred to herein as a single server. However, host server 510 may comprise a plurality of servers or other computing devices or systems interconnected by hardware and software systems known in the art which collectively are operable to perform the functions allocated to host server 510 in accordance with the present disclosure. Host server 510 may also comprise a plurality of servers or other computing devices or systems at a plurality of geographically distinct locations interconnected by hardware and software systems known in the art which collectively are operable to perform the functions allocated to host server 510 in accordance with the present disclosure.

In at least one embodiment, the host server 510 may include two host server programs, namely “Build Manager” and “Injection Manager.” The Build Manager may be configured to perform the tasks described in reference to step 110 above, as well as step 120. Similarly, the Injection Manager may be configured to perform the tasks described in reference to step 130 above, as well as step 120. It should also be noted that the host server 310 may include another host server program, namely “Controller.” The Controller may be configured to perform the tasks described above regarding determining when to build and send an email, determining what Send Center to send a constructed email to, and determining what form to send a message in a Send Job. As a result, the Controller may be configured to communicate with the Building Manager, blocking queue (described below), and Injection Manager so as to provide instructions of when to build and send emails.

The Build Manager and Injection Manager may transfer information (e.g. data or instructions) to one another using one or more blocking queues (e.g., durable blocking queue), which generally allow for blocking of functionality in some circumstances and sharing of work. The Build Manager may be configured, for example, to sort through batch files, assemble individual emails using the batch files, and write information relating to the individual emails to the one or more blocking queues, while the Injection Manager may be configured, for example, to read from the one or more blocking queues and inject the emails into an MTA. It should be noted that the blocking queues may be part of the server that operates one or both of the Build Manager and Injection Manager or it may its own system and may include an injection router.

In at least one embodiment, the system and method of the present disclosure balance and prioritize the threads of each of the Build Manager and Injection Manager to improve efficiency and optimize message delivery. As used herein, a “thread” is the smallest unit of processing that can be scheduled by an operating system. A process is an instance of a running computer program, where one or more threads are running In some cases, the term “main thread” may be used to describe the thread that is started when the process is started and is the primary arbiter of other threads that are running. The other threads that are running in parallel are often termed “worker threads.”

The number of email items in the one or more blocking queues generally governs the number of worker threads under the direction of the Build Manager and the Injection Manager. Typically, the Build Manager will begin operating with one thread and will assemble the first two emails (or other number of emails) and examine the state of the one or more blocking queues. If the one or more blocking queues are empty, the Build Manager will start a new thread and then both threads will assemble emails in parallel and place them in the one or more blocking queues. This Build Manager will repeat this process until the one or more blocking queues are either discovered to not be empty or the Build Manager has a maximum of number of worker threads (e.g., three worker threads).

Typically, the Injection Manager will begin operating with one thread. The Injection Manager will monitor the one or more blocking queues and when something arrives in the one or more blocking queues, it will inject that email into an MTA. The Injection Manager will also monitor the length of each blocking queue. In one example, if a blocking queue length sustains a greater than zero length, another worker thread may be started, allowing two threads to inject emails into the MTA in parallel. The Injection Manager may continue this process until either the blocking queue becomes empty, such as for a predetermined amount of time, or the Injection Manager has a maximum number of worker threads running (e.g., three worker threads).

The number of worker threads for each of the Build Manager and Injection Manager may be balanced, for example, based upon the determination of when to build emails, where to route email data for injection, and when to inject the emails. In one embodiment, the system and method of the present disclosure may be self-monitoring and self-correcting to balance the worker threads. For example, various algorithms may be implemented to autonomously make decisions of when to build and deliver emails to balance the worker threads. Of course, the method and system of the present disclosure may include decision-making by a human in order to balance the worker threads of the Build Manager and Injection Manager. For example, a user may determine when emails should be built and delivered.

Both the Build Manager and the Injection Manager may be configured for writing back information about the Send Job to a database (described below). This documentation task may generally be handled by the main manager thread of each Manager.

According to the present disclosure, database 515 is coupled to host server 510 and in some instances, may reside on host server 510. Database 515 is also coupled to host server 510 where database 515 resides on a server or computing device remote from host server 510, provided that the remote server or computing device is capable of bi-directional data transfer with host server 510. Preferably, the remote server or computing device upon which database 515 resides is electronically connected to host server 510 such that the remote server or computing device is capable of continuous bi-directional data transfer with host server 510.

For purposes of clarity, database 515 is shown in FIG. 5, and referred to herein as a single database. It will be appreciated by those of ordinary skill in the art that database 515 may comprise a plurality of databases connected by software systems of a type well known in the art, which collectively are operable to perform the functions assigned to database 515 according to the present disclosure. Database 515 may comprise a relational database architecture or other database architecture of a type known in the database art. Database 515 may comprise one of many well known database management systems, such as, for example, MICROSOFT®'s SQL® Server, MICROSOFT®'s ACCESS®, or IBM®'s DB2® database management systems, or the database management systems available from ORACLE® or SYBASE®. Database 515 retrievably stores information that is communicated to database 315 from first remote device 505 through computer network 525. In one embodiment, database 515 may also retrievably store information that is communicated to database 515 from second remote device 520 through computer network 525.

First remote device 505 communicates with host server 510 via computer network 525 and second remote device 520 communicates with host server 510 via computer network 527. For purposes of clarity, computer network 525 and computer network 527 are shown in FIG. 5 as distinct computer networks. However, computer networks 525 and 527 may comprise the same computer network. The communication between first remote device 505 and second remote device 520 and host server 510 may be bi-directional. Computer networks 525 and 527 may comprise the Internet, but this is not required. Other networks, such as Ethernet networks, cable-based networks, and satellite communications networks, well known in the art, and/or any combination of networks are contemplated to be within the scope of the disclosure.

Referring now to FIG. 6A, there is shown one embodiment of a system to support the management of Send Jobs according to at least one embodiment of the present disclosure. As shown in FIG. 6A, the system 600 includes a database 601, a build manager 602, three Send Centers 603, 604, and 605, each Send Center with an Injection Manager 606, 607, and 608 and each Send Center with a MTA 609, 610, 611. It should be appreciated that although there are only three Send Centers 603, 604, and 605 shown in FIG. 6A, the system 300 may include any number of Send Centers.

In at least one embodiment of the present disclosure, the system 600 includes a database 601. The database 601 contains the activity data necessary in order to build and construct emails for the Send Job. In at least one embodiment of the present disclosure, the database 601 is coupled to the Build Manager 602. According to at least one embodiment of the present disclosure, the Build Manager 602 pulls activity data from the database 601 and constructs and builds emails according to an email request and using the activity data.

When executing the method 200 as disclosed in FIG. 2, the Build Manager 602 receives the request to build an email in step 202. In at least one embodiment of the present disclosure, the Build Manager 602 pulls activity data from the database 601 in step 204. After pulling activity data from the database 601 in step 204, the Build Manager builds and constructs emails in step 206. It should be appreciated that the database 601 and the Build Manager 602 may reside in the same geographic location or distinct geographic locations and may be electronically coupled over a network, such as, for example, the Internet with bi-directional communication.

In at least one embodiment of the present disclosure, the system 600 includes at least one Send Center. As shown in FIG. 6A, three Send Centers are shown, including the Japan Send Center 603, the United States Send Center 604, and the United States Disaster Recovery Send Center 605. In at least one embodiment of the present disclosure, each Send Center includes an Injection Manager 606, 607, and 608 and a MTA 609, 610, and 611. It should be appreciated that it is within the scope of the present disclosure that the Injection Managers and the MTAs each may include more than one server or may reside as cloud infrastructure. For example, the MTA 609 in the Japan Send Center 603 may include six servers that are managed by a load balancer (not pictured). In this example, the load balancer would receive emails from the Injection Manager 606 and spread the load of incoming emails to the multiple MTA servers 609 through a load balancing function.

In at least one embodiment of the present disclosure, the Build Manager 602 is electronically coupled through a network, such as, for example, the Internet, to the Send Centers 603, 604, and 605. In such an embodiment, the Build Manager 602 routes emails to the appropriate Send Center for injection into the Injection Manager at the Send Center. As discussed previously, the Build Manager 602 sends each constructed email to the appropriate Send Center based on geographic proximity to the recipient, throughput of the Send Center, or other evaluation criteria within the scope of the present disclosure.

For example, in the event that the Build Manager 602 builds an email for a recipient with an email address that ends in “.jp”, the Build Manager 602 sends the email to the Injection Manager 606 and the Japan Send Center 603. In another example, in the event that the Build Manager 602 builds an email for a recipient with an email address that ends in “.us”, the Build Manager 602 evaluates the throughout capacities of the United States Send Center 604 and the United States Disaster Recovery Send Center 605 to determine whether the Build Manager 602 should send the email to Injection Manager 607 at the United States Send Center 604 or the Injection Manager 608 at the United States Disaster Recovery Send Center 605.

Referring now to FIG. 6B, there is shown one embodiment of a system that may be utilized to manage Send Jobs where there are multiple Build Managers in geographically distinct locations. Although only two geographic locations 621 and 622 are shown in FIG. 6B, it should be appreciated that the system 620 may include any number of geographically distinct locations. As shown in FIG. 6B, activity data is stored in a database 602. This database 601 may be geographically distinct from the first geographic location 621 and the second geographic location 622. The database 601 may also reside on a server or servers within the first geographic location 621 or the second geographic location 622. Nevertheless, the database 601 is electronically coupled to the first geographic location 621 and the second geographic location 622 via computer network, like, for example, the Internet.

In FIG. 6B, a first geographic location 621 is shown electronically coupled to the second geographic location 622. It should be appreciated that more than two geographic locations may be used in this method and system. All geographic locations, including the database 601, can be electronically coupled together through a computer network, like, for example, the Internet. The communication between servers at each geographic location may be bi-directional.

In at least one embodiment of the present disclosure, the database 601 include activity data that may be obtained through data files. In such an embodiment, the data files are transferred from the database 601 to the Build Manager 623 at the first geographic location 621 and the Build Manager 624 at the second geographic location 622. In at least one embodiment of the present disclosure, activity data may also be transmitted directly to the Build Mangers from the database 601 or pulled from the database 601 by a Build Manager at each geographic location through a direct database connection, SOAP service, web service, FTP connection, SSH connection, or other communication protocol between servers. Data files containing activity data may also be compressed before or during the transfer to one or more geographically distinct locations.

In at least one embodiment of the present disclosure, the Build Manager 623 at the first geographic location 621 can process and import the activity data received through data files. It should be appreciated that each geographic location may process only a subset of the activity data or may process the entire set of activity data. By example, the subset of the activity data may be defined for each geographic location by randomly assigning a value between 0 and 1 to each record in the activity data. As in this example with two geographic locations, the subset for the first geographic location 621 would be all records in the activity data with a randomly assigned value less than 0.5 while the unique subset for the second geographic location 622 would be all records in the activity data with a randomly assigned value greater than or equal to 0.5. If all activity data is processed at each geographic location, then to improve processing time, the subset for each geographic location can be processed and Send Jobs would be scheduled for the subset before processing the activity data not within the subset. It should be noted that the choice of subset may be decided based upon the factors described herein for determining when and where to construct an email.

During the process, the Build Manager 623 at the first geographic location 621 can coordinate records processed and emails built with the Build Manager 624 at the second geographic location 622 through coordination operations. In one embodiment, these coordination operations are network connections and syncing processes between Build Managers at each geographic location. The network connection and syncing process between Build Managers may include, but is not limited to, a direct database connection, IBM® Change Data Capture, ORACLE® Golden Gate, MICROSOFT® SQL® Server replication, MYSQL® Cluster Replication, or any other database connection method used to keep content in sync.

In at least one embodiment of the present disclosure, the coordination operations include coordinating between the Build Manager 623 at the first geographic location 621, the Build Manager 624 at the second geographic location 622, and a witness 626. In such an embodiment, the witness 626 monitors both the Build Manager 623 and the Build Manager 624. In the event that the witness 626 determines that either the Build Manager 623 or the Build Manager 624 is unavailable, the witness 626 notifies the available Build Manager. In such an embodiment, the available Build Manager processes the remaining emails of the subset assigned to the unavailable Build Manager. In at least one embodiment of the present disclosure, the Build Manager 623, the Build Manager 624, and the witness 626 coordinate together to identify whether one of the Build Managers is unavailable. In such an embodiment during coordination, at least two of the Build Manager 623, the Build Manager 624, and the witness 626 notify that a Build Manager is available or unavailable. In the event that a Build Manager cannot receive at least two of the Build Manager 623, the Build Manager 624, and the witness 626 to notify that the Build Manager is available, then such Build Manager is determined to be unavailable.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

What is claimed is:

1. A method for managing email send jobs, the method comprising:
constructing and building a plurality of emails based upon an executable process, wherein each of the plurality of emails comprises an activity data and at least one email recipient;
routing each of the plurality of emails to a queue at a location, wherein the location is determined based in part upon proximity to at least one of the at least one email recipient;
processing each of the plurality of emails within each queue;
injecting each of the plurality of emails into a mail transfer agent at the location; and
sending each of the plurality of emails to the at least one email recipient.

2. The method of claim 1, wherein the executable process is an email request generated from a marketing campaign.

3. The method of claim 1, wherein proximity is selected from the group consisting of geographic closeness, lowest latency, and nearness within a series.

4. The method of claim 1, wherein the location is determined by evaluating the latency between a plurality of locations and the at least one email recipient.

5. The method of claim 1, wherein the first executable process is performed on a plurality of servers at geographically distinct locations, wherein each of the plurality of servers are electronically coupled together by a network.

6. The method of claim 5, further comprising:
assigning a subset of the plurality of emails to each of the plurality of servers; and
wherein the routing step includes each of the plurality of servers routing the assigned subset to a queue at the location.

7. The method of claim 6, further comprising:
coordinating between each of the plurality of servers at geographically distinct locations to determine whether each of the plurality of servers is available; and
in the event that at least one of the plurality of servers is unavailable, assigning the subset assigned to each of the unavailable servers to at least one of the plurality of servers that is available.

8. The method of claim 1, wherein the location is determined by evaluating a domain of the at least one email recipient with a plurality of locations.

9. A method for managing send jobs with disaster recovery, the method comprising:
obtaining an activity data associated with an email campaign;
building a plurality of emails based on the activity data at a plurality of geographic locations;
assigning a subset of the plurality of emails to each of the plurality of geographic locations;
routing each of the subsets of the plurality of emails from the each of the plurality of geographic locations to at least one mail transfer agents; and
sending the plurality of emails from the at least one mail transfer agents.

10. The method of claim 9, further comprising:
determining whether at least one the plurality of geographic locations is unavailable; and
in the event that at least one of the plurality of geographic locations is unavailable, assigning the subset of the plurality of emails to at least one available geographic location.

11. The method of claim 9, wherein each of the subsets of the plurality of emails is routed from the each of the plurality of geographic locations to at least one mail transfer agent based on the proximity of the mail transfer agent to an email recipient associated with each of the plurality of emails.

12. The method of claim 11, wherein proximity is selected from the group consisting of geographic closeness, lowest latency, and nearness within a series.

13. The method of claim 11, wherein proximity is determined based on the country where each of the mail transfer agents is located and a domain associated with the email recipient.

14. The method of claim 11, wherein proximity is determined based upon a latency between each of the mail transfer agents and the email recipient.

15. A system for managing send jobs comprising:
a database, the database storing activity data for an email campaign;
a first server electronically coupled to the database, the server receiving an activity data from the database and building a plurality of emails based on the activity data, wherein each of the plurality of emails includes an email recipient;
a plurality of send centers, each send center comprising a mail transfer agent;
wherein the first server sends each of the plurality of emails to the mail transfer agent at one of the send centers based on the proximity of the send center to the email recipient; and
wherein the mail transfer agent sends the emails to the email recipients.

16. The system of claim 15, further comprising:
a queue at each of the send centers;
wherein the first server sends each of the plurality of emails to the queue at one of the send centers based on the proximity of the send center to the email recipients; and
the queue injects the emails to the mail transfer agent at the send center.

17. The system of claim 16, further comprising:
a second server at a geographically distinct location from the first server and electronically coupled to the database, the second server receiving the activity data from the database and building the plurality of emails based on the activity data;
wherein a first subset of emails is assigned to the first server and a second subset of emails is assigned to the second server;
wherein the first server sends the first subset of emails to the mail transfer agent at one of the send centers based on the proximity of the send center to the email recipient; and
wherein the second server sends the second subset of emails to the mail transfer agent at one of the send centers based on the proximity of the send center to the email recipient.

18. The system of claim 17, further comprising:
an interconnect between the first server and the second server, wherein the first server and the second server communicate a status over the interconnect; and
in the event the status indicates that the first server is unavailable, the second server sends the first subset of emails to the mail transfer agent at one of the send centers based on the proximity of the send centers to the email recipient.

19. The system of claim 17, further comprising:
an interconnect between the first server and the second server, wherein the first server and the second server communicate a status over the interconnect;
wherein the first server sends a subset of the second subset of emails to the mail transfer agent at one of the send centers based on the proximity of the send centers to the email recipient.

20. A method of disaster recovery, the method comprising:
coordinating between a plurality of processing centers each assigned a subset of tasks a status of an email job and an availability status;
determining based on the availability status whether at least one of the plurality of processing centers is unavailable; and
in the event at least one of the plurality of processing centers is unavailable, rerouting the subset of tasks of the at least one of the plurality of processing centers that is unavailable to the other of the plurality of processing centers.

21. The method of claim 20, wherein the subset of tasks includes building, routing, and sending emails.

22. The method of claim 20, wherein the coordinating step further comprises a witness establishing a second availability status of each of the plurality of processing centers.

23. The method of claim 22, wherein each of the plurality of processing centers is determined to be unavailable based on the availability status and the second availability status.
